(19) United States
(12) Patent Application Publication
(10) Pub. No.: US 2005/0108170 A1
(43) Pub. Date: May 19, 2005

(54) Secured method and apparatus for selling and distributing software and related services

(76) Inventors: Brent T. Hailpern, Katonah, NY (US); John J. Turek, S. Nyack, NY (US); Philip Shi-Lung Yu, Chappaqua, NY (US)

Correspondence Address: Moser, Patterson & Sheridan, Suite 100, 595 Shrewsbury Avenue, Shrewsbury, NJ, 07702, US

(21) Appl. No.: 10/715,287

(22) Filed: Nov. 17, 2003

(51) Int. Cl. G06F 17/60

(52) U.S. Cl. 705/51

(57) ABSTRACT

A method for distributing and utilizing software is provided. In the method of distribution, a software application is provided on a hardware device by a manufacturer of the software application, wherein the software application is executable on the hardware device. The hardware device is enclosed within a box and distributed. The manufacturer provides continued services for the software application, wherein the hardware device is connectable between at least one end user's computer and the manufacturer. The hardware device is adapted to provide the continued services via a communication link between the hardware device and the manufacturer.

### BACKGROUND OF THE INVENTION

1. Field of the Invention

The present invention relates generally to software distribution. More specifically, the invention relates to a method and apparatus for distributing software and providing associated services therefor.

2. Description of the Related Art

The traditional way of selling a software product is to write the software onto a medium (e.g., a CD-ROM (“CD”), or a diskette) and then sell the software to the customers. A customer purchases the software CD and then installs the software from the CD onto his computer(s). Another traditional method of distributing software is to download the software from a web site onto a client's computer and then install it. However, there are several problems associated with each of these approaches.

First, manufacturers of software products generally need to test the software over hundreds of different hardware and software configurations of client machines to ensure that it can be installed properly by the customers. In addition, installation of the software by customers can fail due to conflicts caused by other software or hardware components already installed on the client computer. As a result, customer support needs to be provided to help address the installation or run time problems associated with software installation. The costs incurred by the software developer due to testing and customer support can be substantial. In addition, any downtime associated with non-installation of the software may in some instances cause the client to incur substantial costs.

Second, using CD as a means to distribute software makes illegal copying of software trivial. The cost associated with pirated software is substantial to the software developer.

Third, the two methods discussed above do not provide an easy and cost effective means for the manufacturer to provide continued service to the customers. Namely, customers generally will buy the software, but will rarely, if ever, subscribe to additional associated services provided by the software manufacturer.

Thus there is a need for an innovative method and apparatus for distributing software and providing associated services for the distributed software.

### SUMMARY OF THE INVENTION

The present invention generally provides a secured method of selling and distributing software and related services; and utilizing the received software. In the method of distribution, a software application is provided on a hardware device by a manufacturer of the software application, wherein the software application is executable directly on the hardware device. The hardware device is enclosed within an enclosure (e.g., a tamper resistant enclosure) and distributed to the customers. The manufacturer may provide associated services for the software application, wherein the hardware device is connectable between at least one end user's computer and the manufacturer or potentially with a third party provider of the associated services. The hardware device is adapted to provide the associated services via a communication link between the hardware device and the manufacturer (e.g. a web site or a computer system operated by the software manufacturer) or a third party provider of the associated services.

### BRIEF DESCRIPTION OF THE DRAWINGS

The teaching of the present invention can be readily understood by considering the following detailed description in conjunction with the accompanying drawings, in which:

FIG. 1 depicts an illustrative software distribution method in accordance with the invention;

FIG. 2 depicts an example of a client system in accordance with the invention;

FIG. 3 an alternative embodiment of a client system in accordance with the invention;

FIG. 4 depicts an example of a software activation method;

FIG. 5 depicts an example of a method 500 for providing the services requested by the user; and

FIG. 6 depicts a block diagram of a system in accordance with the invention.

To facilitate understanding, identical reference numerals have been used, wherever possible, to designate identical elements that are common to the figures.

It is to be noted, however, that the appended drawings illustrate only typical embodiments of this invention and are therefore not to be considered limiting of its scope, for the invention may admit to other equally effective embodiments.

### DETAILED DESCRIPTION OF THE PREFERRED EMBODIMENT

The present invention generally provides an alternative means of distributing software. Specifically, the software is distributed through a hardware enclosure (e.g., a closed hardware box), where it prevents unauthorized parties (e.g., users) from (1) downloading/copying or adding/modifying/deleting any software pre-installed in the hardware enclosure; (2) from accessing/copying the data on its storage devices; (3) from changing the hardware configuration. However, it will allow users to submit data to the hardware enclosure for processing by the installed software application and allow the software manufacturer to provide continuing services through a web connection with the hardware enclosure.

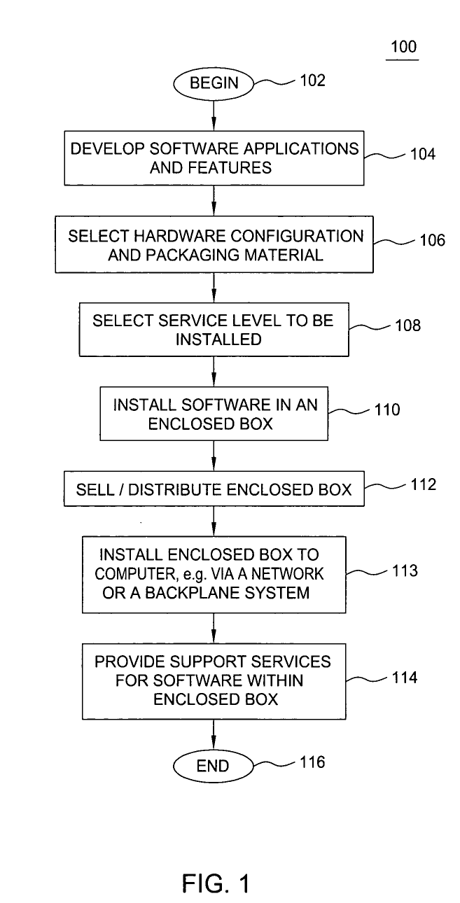

FIG. 1 depicts an illustrative software distribution method 100, in accordance with the invention. The method 100 begins at step 102 and proceeds to step 104.

At step 104, the code of the software application is developed with the appropriate features. For example, if the software application is an application which provides tax services (e.g., TURBO TAX, produced by Intuit, Inc. of Mountainview, Calif.) an appropriate feature is the preparation of tax forms. The method then proceeds to step 106.

At step 106, the manufacturer may select a particular hardware configuration and packaging material to host the software. In selecting the hardware configuration or the hardware capability, the manufacturer determines the appropriate processor type, the CPU speed, the memory and storage size, and the network connection options. Namely, a manufacturer may optionally offer the software in different hardware configurations to suit the needs of different users. In one embodiment, the enclosure may implement tamper resistant devices or packaging such as the IBM 4758 cryptocard which is a high security, programmable PCI board. Specialized cryptographic electronics, micro-processor, memory, and random number generator housed within a tamper-responding environment provide a highly secure subsystem in which data processing and cryptography can be performed. The IBM 4758 cryptocard is only disclosed here as an example and is not intended to limit the present invention. The method proceeds to step 108.

At step 108, the manufacturer selects the service level to be included with the software application package. Some associated on-going services include upgrades, backup/mirroring of data, maintenance/warranty service and new functionalities, such as a usage based charging mechanism. For example, in a tax form software application, potential services may include but are not limited to the software manufacturer providing updated tax forms, the software manufacturer forwarding the client's information to an online tax auditing service, and/or the software manufacturer electronically filing the client's tax forms.

In another example, the software application can be an accounting program (e.g., QUICKBOOKS, produced by Intuit, Inc. of Mountainview, Calif.). In this example, the web based appropriate features may include provisions which allow the software manufacturer to forward the client's information to a check writing service.

In yet another example, the software application can be a backup service. These backup services are not limited by the backup protocol utilized. For example, the protocols used may include but are not limited to the Network File System (“NFS”), Distributed File System (“DFS”), and the Andrew File System (“AFS”) protocols. In addition, the continued service may include the software manufacturer forwarding the end user's data to a storage facility. The backup service can be accomplished with some mechanism provided for privacy protection of user data. This protection may also protect the user's privacy against the vendor/manufacturer. One approach is to use encryption to protect the privacy of the customers. The manufacturer can provide not only backup service, but also mirroring service which will provide a fast recovery time for critical applications. Maintenance service can be performed through remote diagnosis via the internet or other network.

As in the case of an upgrade or update, performing maintenance to a closed box is far easier in contrast to a general purpose client machines which can have any hardware and software configuration. In a closed box environment, the manufacturer has precise knowledge of the configuration and can hence better determine the appropriate diagnostic information to collect or monitor. It can also collect diagnostic information to provide preventive maintenance. The new functionality, for example, can be a payment method based on metering of the usage, i.e., a usage based charging mechanism.

Each of these appropriate features can be provided via the “web” or other networks. In order for the software manufacturer to provide such appropriate features for the continued services, programming code is included which allows the software manufacturer to view the software application and some of the information input by the end user (i.e., the software manufacturer has limited access to the end user's information on the hardware device). In addition, programming code is included which prevents an unauthorized user from copying, downloading, or altering the application software.

At step 110, the software application is installed within the selected enclosed box with the selected level of services. Installing the software in such an enclosed box provides several advantages. First, the software application is executable on the hardware within the enclosed box. Thus, a customer can access the software application by simply connecting an additional box to a receptor, e.g., a backplane with slots for receiving a plurality of such enclosed boxes, that is connected to the client machine, instead of installing the software to his machine. The closed box not only eliminates the testing and support problem on the software product over countless software and hardware configurations, but it also prevents the problem of illegal copying of the software. Furthermore, it supports a new capability of providing direct service from the software manufacturer to the customers. The service can be auto-updates on software patches, upgrades, maintenance, backup of data and new functionalities, such as usage based charging mechanism. When a new software patch is released the new patch can be automatically installed, by the software manufacturer, through the internet or other networks. An update or upgrade is straightforward because the operation is performed, by the software manufacturer on an enclosed box. The manufacturer has full or exact knowledge on the hardware and software configuration of the enclosed box. This is in contrast to a client machine where there are too many variables due to the specific hardware and software configurations that can cause numerous problems during an update or upgrade operation.

The software manufacturer distributing a software application via an enclosed box is advantageous for several reasons. First, the ever decreasing hardware cost makes the distribution through an enclosed box affordable. Second, the availability of the software within the enclosed box to a network, via a wireless access or USB port, etc., makes a separately packaged hardware box directly accessible to other computers through a network, e.g., a home network. Third, the advancement of software technology and standards such as web services makes the interaction between the closed software box and other computers straightforward.

The intent of the present invention is to provide an alternative means for a software manufacturer to distribute software through an enclosed hardware box, where it prevents users from downloading/copying or adding/modifying/deleting any software pre-installed in the closed or sealed box. It also prevents users from changing the hardware configuration. Furthermore, the closed box also prevents user accessing/copying the data on its storage devices. However, it will allow users to submit data to the closed box for processing by the software application. With the closed box approach, a new software application may be installed in a network by merely adding another enclosed box software application provided by the software manufacturer. Because the software application is self-contained in a box, the closed box approach eliminates various testing and support problems, for the software product that may have to operate with over countless software and hardware configurations on client machines.

The closed box approach also makes maintenance easier. Specifically, the software manufacturer can ship an identical box to the customer if necessary, e.g., the box is not functioning properly and/or responding to remote diagnosis. If there is user data stored in the closed box, the software manufacturer can, in one embodiment, use the backup or mirrored data to restore the data in the replacement box. In another embodiment, the user data is stored in the user's computer. As such, the replacement box uses the user's data as the original box would.

The closed box approach also prevents users from accessing the data in the storage devices of the sealed box. This feature can be used to provide applications that can protect data privacy and security. For example, a sealed box application on digital entertainment can enforce copyrights by allowing only listening (for music) or viewing (for video) of the entertainment without allowing the user to copy the digital entertainment data. Another example of data protection is to allow a user to subscribe to certain data sources to support the computation in the sealed box, without direct access to the raw data.

Returning to FIG. 1, at step 112, the enclosed box is distributed. The distribution can take the form of a sale of the enclosed box or licensing of the enclosed box. Upon receipt of the enclosed box, a user interconnects the enclosed box at step 113 with an existing computer, e.g., via a backplane system that is coupled to or is in communication with the user's computer. The user may access the software application through a “window” opened in the software application which allows an existing computer to execute the application program in the enclosed box. There are various embodiments for interconnecting the enclosed box with a user's computer. For example, such connection methods include but are not limited to wireless, local area network, powerline and direct connection via Universal Serial Bus (“USB”) or firewire.

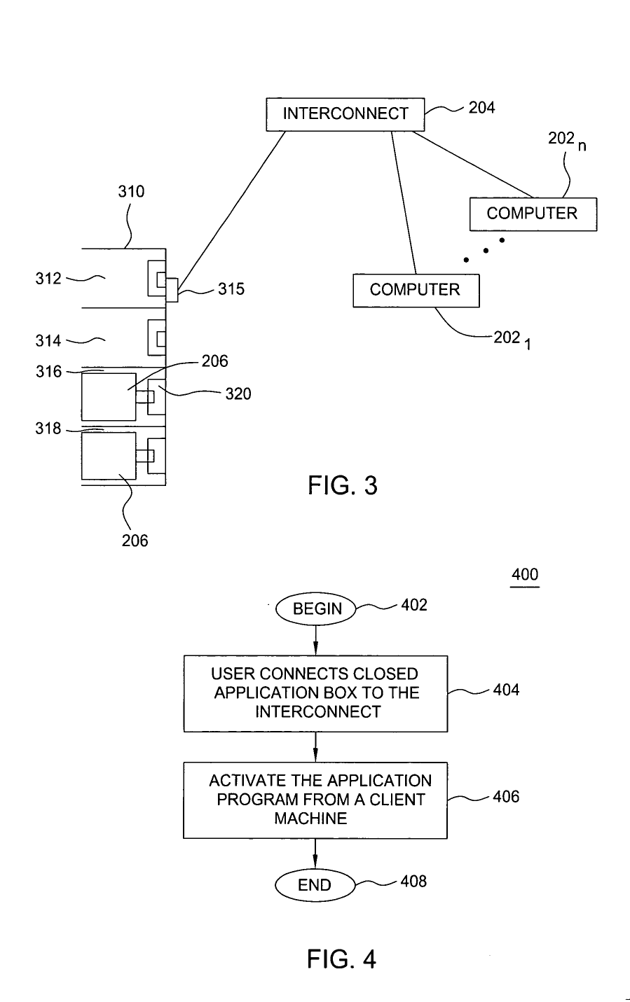

In addition, multiple software application boxes can be connected through a backplane which provides the network connection and/or power supply, where each enclosed application box is inserted into a backplane (as described below in further detail with respect to FIG. 3). In selecting the packaging material, the look and feel (including the size of the box and its power requirement) of the box is determined.

At step 114, the software manufacturer provides such illustrative continued services as described above. The method 100 proceeds to and ends at step 116.

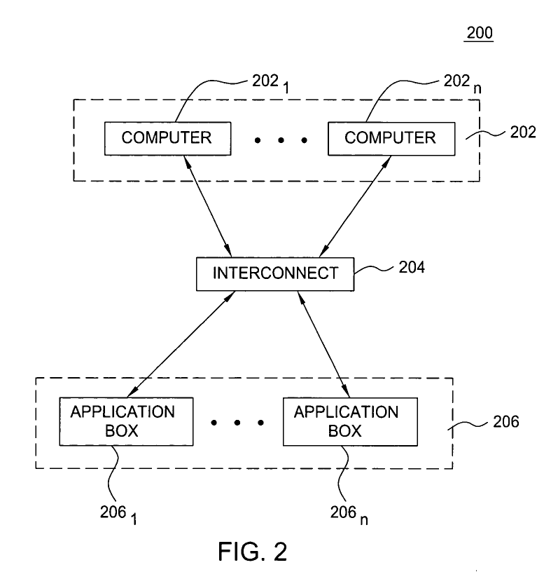

FIG. 2 depicts an example of the client system having features of the present invention. Specifically, FIG. 2 depicts an interconnection system 200. In the interconnection system 200, computers or client machines 202₁ and 202ₙ (collectively computers or client machines 202) are connected to an interconnect 204 to a plurality of application boxes 206₁ and 206ₙ. (collectively application boxes 206). The interconnect 204 can be a LAN such as Ethernet, wireless interconnect, powerline and USB or firewire switch, or direct connect via USB or firewire. The interconnect 204 is broadly defined as a network connection. For simplicity, only two computers/client machines 202 and application boxes 206 are depicted. However, it is appreciated that more or less computers/client machines 202 and application boxes 206 may be used in accordance with the invention. Subsequent software applications can be added to the network by connecting an application box 206 having the software application therein to the interconnect 204.

FIG. 3 depicts an alternative configuration of interconnecting the application boxes 206. Specifically, FIG. 3 depicts computers 202₁ and 202ₙ (collectively computers 202), an interconnect 204, and a backplane 310. The computers 202 and interconnect 204 operate as described with respect to FIG. 2 above. As such and for brevity, the description of these elements will not be repeated.

The backplane 310 reduces the interconnection cost. The backplane 310 comprises multiple slots 312, 314, 316, and 318. Each slot has a slot connector 320. Slots 312 and 314 are empty. However, slots 316 and 318 contain enclosed boxes 206 with each having a software application therein. Each application box 206 is inserted into an empty slot and connected to a corresponding slot connector 320. The backplane has a network interface 315 which can be connected to the interconnect 204. The backplane 310 can also provide power to the application boxes 206.

FIG. 4 depicts an example of an activation method 400 for a software application in the closed box 206. The method 400 begins at step 402 and proceeds to step 404.

At step 404, a user receives the enclosed box 206 and connects the enclosed box 206 to the interconnect 204, as described with respect to FIGS. 2 and 3. The method 400 proceeds to step 406.

At step 406, the user activates the application program from a client machine. There are various methods available to invoke the application software in the closed box 206 from a client machine 202. For example, in one embodiment, the software application program is invoked through a web browser. In another embodiment, software code (such as Java applets) is used to invoke the software application. This software code can either be downloaded from the software manufacturer's web site or from the enclosed box 206. In yet another embodiment, software code provided by the vendor and installed on one of the customer's machines can be used to invoke the software application.

In addition, the software manufacturer can optionally require that the closed box 206 be enabled by the software manufacturer after the lease/purchase of the software application (e.g., by using a software key (e.g., a password, a serial number, and/or an instruction code from the software manufacturer) to unlock the software application). This optional step can, in one embodiment, be accomplished after step 406 via the internet. As web service becomes a standard, the software application can be invoked as a web service.

After activation, the enclosed box 206 can perform a diagnostic to make sure that the local client environment meets certain standards (e.g., bandwidth, installed protocols, drivers or other devices) or has other software already installed, e.g. either communication software needed to perform the required function or digital rights management software to guarantee that copyright isn't violated or some base software package that this box is an add-on to.

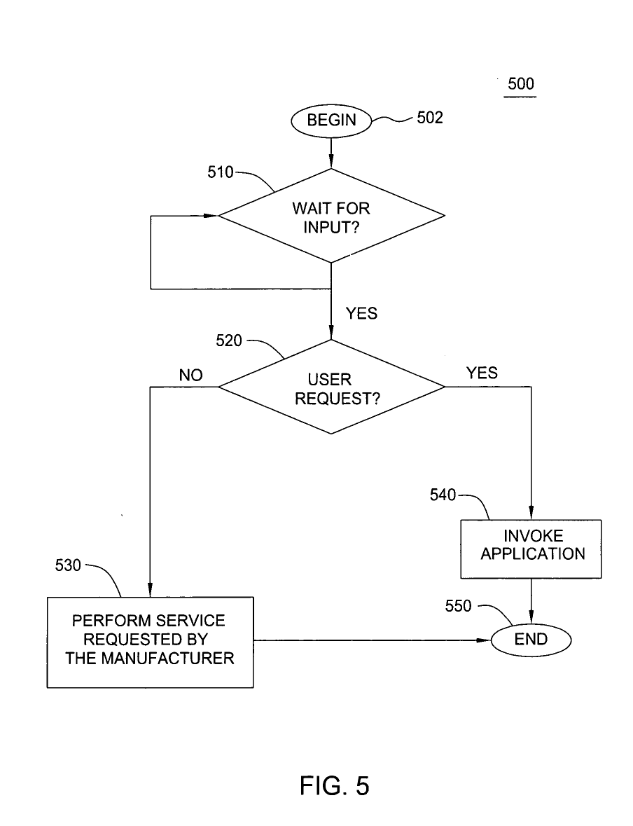

FIG. 5 depicts an example of a method 500 for providing the service requested by the user. Specifically, the method 500 begins at step 502 and proceeds to step 510.

At step 510, the method waits for an instruction. The instruction can be received from either the software manufacturer or the end user's computer. Upon receipt of an instruction, the method proceeds to step 520.

At step 520, the method queries whether the received instruction is from an end user's computer. If answered affirmatively, the method proceeds to step 540. At step 540, the application processes the request received from the user's computer, e.g., initiation of the program, a function of the program, or continued service. If at step 520 the query is answered negatively, the method proceeds to step 530.

At step 530, the method determines that the instruction was received from the software manufacturer and performs the service associated with the received instruction. The service requested by the software manufacturer can be upgrades, backup of data, adding new functionalities, and providing maintenance/warranty service.

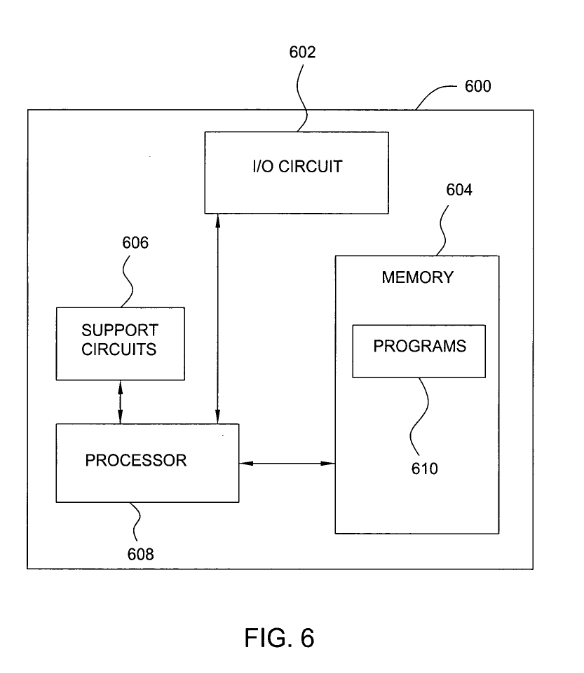

FIG. 6 depicts a high level block diagram of the present invention implemented using a general purpose computing device. In one embodiment, the general purpose computing device 600 comprises a processor 608, a memory 604 for storing programs 610, e.g., application software, and the like, support circuits 606, and Input/Output (I/O) circuits 602. The processor 608 operates with conventional support circuitry 606 such as power supplies, clock circuits, cache memory and the like as well as circuits that assist in executing the software routines stored in the memory 604. Additionally, processor 608 also operates with a plurality of I/O circuits or devices 602 such as a keyboard, a mouse, and storage devices such as a disk drive and/or optical drive and the like. In one embodiment, the present invention for distributing software and related services can be implemented as a software application that is retrieved from a storage medium via the I/O circuits 602 that is loaded into the memory and is then executed by the processor 608. As such, it is contemplated that some and/or all of the steps of the above methods and apparatus can be stored on a computer-readable medium.

In addition, the invention has been illustratively described above, with respect to a manufacturer selecting a hardware configuration and packaging material to host the software application. This illustration is not intended in any way to limit the scope of the invention. For example, in other embodiments, the manufacturer can provide multiple types of packages with different prices based on the software features, hardware configuration, packaging material, and service level for the end user to select. For example, some users may be willing to pay a higher price for a faster hardware configuration, higher level of services, or a particular type of interconnection method. Further, it is appreciated that in various embodiments, the application software can be configured for use in conjunction with a web service. The notion of “web service” represents a suite of protocols, standardized by the w3c and oasis, which include SOAP (Simple Object Access Protocol), XML (Extensible Markup Language), and UDDI (Universal Description Discovery Integration). Namely, instead of a user interacting with information on a web page, a program on the client computer can interact with an application on the box via a web service. Similarly, the box can interact with the provider's computer via some kind of message sending system (e.g., IBM's Websphere/MQ or the like) or via a web service.

While the foregoing is directed to embodiments of the present invention, other and further embodiments of the invention may be devised without departing from the basic scope thereof, and the scope thereof is determined by the claims that follow.

1. A method for distributing software comprising:
providing a software application on a hardware device by a manufacturer of said software application, wherein said software application is executable on said hardware device;
distributing said hardware device; and
providing a continued service for said software application, wherein said hardware device is adapted to provide said continued service via a communication link between said hardware device and said manufacturer.

2. The method of claim 1, wherein the step of providing the continued service is performed by a third party service provider.

3. The method of claim 1, wherein the providing step comprises providing said software application in accordance with at least one of a software feature, a hardware configuration and a packaging material.

4. The method of claim 1, wherein the providing step comprises providing said software application in accordance with a service level.

5. The method of claim 4, further comprising said service level providing a fee rate in accordance with a level of end user usage.

6. The method of claim 1, further comprising said hardware device providing a connection from said at least one end user's computer to said hardware device through at least one of a power line, a local area network, a wireless connection, and a direct connection.

7. The method of claim 6, further comprising said hardware device providing a connection for insertion of said hardware device into a backplane.

8. The method of claim 1, further comprising enclosing said hardware device within an enclosure, thereby preventing an unauthorized downloading of said software application from said hardware device.

9. The method of claim 1, further comprising enclosing said hardware device within an enclosure, thereby preventing an unauthorized uploading of software to said hardware device.

10. The method of claim 1, further comprising enclosing said hardware device within an enclosure, thereby preventing unauthorized altering of the configuration of said application specific hardware device.

11. The method of claim 1, further comprising said hardware device providing a locking feature which requires a key to unlock said software application.

12. The method of claim 1, further comprising:
accessing said hardware device by at least one of a web browser and an access software provided by said software manufacturer.

13. The method of claim 12, further comprising downloading said access software from said software manufacturer or from said hardware device.

14. The method of claim 1, further comprising:
configuring said application software for access in conjunction with a web service.

15. The method of claim 1, further comprising said hardware device providing said software manufacturer with limited access to end user information on said hardware device.

16. A method for utilizing software comprising:
purchasing a software application with a selectable service level of a continued service;
receiving said software application on a hardware device, wherein said software is executable on said hardware device; and
receiving said continuing service from a software manufacturer of said software application in accordance with said selectable service level.

17. The method of claim 16, further comprising said hardware device providing said software manufacturer with limited access to end user information on said hardware device.

18. The method of claim 16, wherein said purchasing step comprises purchasing said software in accordance with at least one of a requested software feature and a user selected service level.

19. The method of claim 16, further comprising including in said user selected service level a fee rate in accordance with a level of end user usage.

20. The method of claim 16, further comprising:
utilizing a key to unlock said software application.

21. The method of claim 16, further comprising;
accessing said software application via at least one of a web browser and an access software provided by said software manufacturer.

22. The method of claim 16, further comprising downloading said software from said software manufacturer or from said hardware device.

23. The method of claim 16, further comprising:
utilizing said software application in conjunction with a web service.

24. A system for using software applications comprising:
an end user computer;
at least one hardware device having a software application executable in said hardware device, wherein said hardware device is provided by a manufacturer of said software application; and
a network adapted to connect said at least one hardware device to said end user computer.

25. The system of claim 24, further comprising:
a backplane adapted to receive said at least one hardware device, wherein said backplane is coupled to said end user computer via said network connection.

26. The system of claim 24, wherein the software application is provided with a selectable service level of a continued service offered by said software manufacturer.
